(19) United States
(12) Patent Application Publication
(10) Pub. No.: US 2017/0195399 A1
(43) Pub. Date: Jul. 6, 2017

(54) ELECTRONIC COMMERCE SYSTEM CAPABLE OF AUTOMATICALLY RECORDING AND UPDATING INFORMATION STORED IN WEARABLE ELECTRONIC DEVICE BY CLOUD END

(71) Applicant: FuelStation Inc., Apia (WS)

(72) Inventor: Mike CHEN, New Taipei City (TW)

(73) Assignee: FuelStation Inc., Apia (WS)

(21) Appl. No.: 15/073,918

(22) Filed: Mar. 18, 2016

(30) Foreign Application Priority Data
Dec. 31, 2015 (TW) 104144668

(51) Int. Cl. H04L 29/08; H04W 4/00

(52) U.S. Cl. CPC H04L 67/06; H04L 67/10; H04W 4/008; H04L 67/306

(57) ABSTRACT

The present invention is to provide an electronic commerce system including a wearable electronic device, a network communication device, an information management server and a streaming audio server, wherein the wearable electronic device is configured to measure a client's body signal and upload the same as a body signal record, as well as uploading an audio property of a audio file being played by the wearable electronic device as an audio preference record, to the network communication device through short-range communication elements; the network communication device is configured to link with the cloud end through a long-range wireless communication element; the information management server is located in the cloud end and configured to store the records to corresponding database respectively; the streaming audio server is located in the cloud end and configured to download audio files stored therein to the wearable electronic device according to the audio preference record.

### FIELD OF THE INVENTION

The present disclosure generally relates to an electronic commerce system, more particularly to an electronic commerce system capable of automatically recording and updating information stored in at least one wearable electronic device by a cloud end such that, under the condition without being provided with large volume memory and rechargeable battery, the wearable electronic device is able to periodically upload a body signal record (such as the client's temperature, heartbeat, blood pressure, consume calories, and so on) and an audio preference record (such as a singer name, a band name, a music style, a news type, an author name, an audiobook style and so on) stored therein to an information management server located in the cloud end just through a short-range wireless communication element, and then periodically download and listen the latest and most diverse audio files from various streaming audio servers located in the cloud end based on the client's preference through the management of the information management server.

### BACKGROUND OF THE INVENTION

In recent year, with rapid development of electronic and communication technology, a handheld electronic device (such as a smart watch, a smart phone, a tablet computer and so on) has not only a strong communication function but also various application functions for meeting a user's demand in daily life, work, social intercourse and entertainment, for example, the functions of noting, timer, counting, scheduling, lighting, taking picture, recording video, GPS, drawing, statistical computing, meeting, investment, withdrawing money, shopping, booking ticket, making a reservation, ordering food, chat, social intercourse, game, and so on. Therefore, the handheld electronic devices become important devices indispensable for most modern people, and the scene that everyone holds a wearable device also becomes ubiquitous in an urban area.

A mobile telephone of iPhone series, manufactured by Apple Inc., is taken as an example for illustration. In order to meet the constant trend that people have to use mobile telephone anywhere and anytime, the Apple Inc. changes the shape design of the mobile telephone of iPhone series from a compact, light and small-sized shape (a length, a width and a thickness of the first-generation iPhone respectively are 115 mm, 61 mm and 11.6 mm) to a thinner and larger-sized shape (a length, a width and a thickness of the latest-generation iPhone respectively are 158.1 mm, 77.8 mm and 7.1 mm), so as to facilitate people to hold the iPhone by hand and view screen clearly. This trend in shape design also drives other mobile telephone manufactures to jump onto the bandwagon, so as to enable the mobile telephone with a big screen and an ultra-thinness to become current mainstream for the smart phone. The conventional mobile telephone with the compact and small-sized shape is suitable to be placed in a pocket of clothes or pants, but the current mobile telephone is not suitable, so the scene of everyone holding a wearable device is ubiquitous in urban area.

Holding a smart phone on hand can satisfy the person's inexplicable demand, but it also require the person to hold the smart phone on hand or hang the smart phone on wrist or arm for just listening audio (such as music, news, audiobook and so on) during sport, mountain climbing, hiking or other leisure activity, which causes inconvenience in the activity, and people may fall or throw the mobile telephone to drop on the ground from the hand, wrist or arm because of personal carelessness or collision by other person or object, so as to damage the mobile phone or its display. Besides, the smart phone dropped on the ground may also be trample by other person or rolled by a passing vehicle, to be completely broken and not available. In this case, the owner of the smart phone has no idea who to claim reparation and also feels miserable and loses interest in activity.

What is need is to develop a wearable electronic device capable of periodically interchanging information with a cloud end in network by just a short-range wireless communication element through a network communication device (such as a smart watch, a smart phone, a tablet computer, a notebook computer, a desktop computer or a charging device having a network communication function) without high-power Ethernet communication element, long-range wireless communication element and relevant communication connection interface. The network communication device can be carried by the client or usually in contact with the client. Without being provided with large-volume memory and rechargeable battery, the wearable electronic device can periodically utilize the strong management and storage functions of the information management server located in a cloud end to store and manage a body signal record (such as the client's temperature, heartbeat, blood pressure, consume calories, and so on) and an audio preference record (such as a singer name, a band name, a music style, a news type, an author name, an audiobook style and so on) stored in the wearable electronic device, and also periodically download the latest and most diverse audio files from various streaming audio servers located in the cloud end based on the client's preference for the client to listen. Therefore, the wearable electronic device can be designed to be more compact, lighter, and have lower power consumption, so as to be conveniently worn on the client and enable the client to measure the body signal and listen audio in considerable time by just using a small-volume rechargeable battery.

### SUMMARY OF THE INVENTION

An objective of the present disclosure is to provide an electronic commerce system capable of automatically recording and updating information stored in at least one wearable electronic device by a cloud end. The electronic commerce system includes at least one wearable electronic device, at least one network communication device, an information management server and at least one streaming audio server. The at least one wearable electronic device is configured to be worn on a client and at least includes a microprocessor, a storage element, at least one body signal detection element, an audio play element and a first short-range wireless communication element. The microprocessor is electrically connected with the storage element, the at least one body signal detection element, the audio play element and the first short-range wireless communication element respectively and configured to execute a plurality of application programs stored in the storage element to control the audio play element to play a plurality of audio files stored in the storage element. The microprocessor is further configured to store the client's body signal measured by the at least one body signal detection element to the storage element as a body signal record. The microprocessor is further configured to store an audio property of the audio file being played by the audio play element to the storage element as an audio preference record, and the microprocessor is configured to interchange and update information of the plurality of application programs, the audio files, the body signal record and the audio preference record to an external device through the short-range communication element. The at least one network communication device includes a second short-range wireless communication element, an Ethernet communication element and a long-range wireless communication element, and is configured to link with the wearable electronic device through the first and second short-range wireless communication elements, and configured to link with internet network through the long-range wireless communication element or directly through the Ethernet communication element, so as to perform information interchanging and updating. The information management server is located in a cloud end of the internet network and linked with the internet network, and includes a first member database, a body signal database and a first audio preference database. The first member database is configured to store basic information of each of members, and the first audio preference database and the body signal database are configured to respectively store an audio preference record and a body signal record of each of the members. The at least one streaming audio server is located in the cloud end of the internet network and linked with the internet network, and includes a second member database, a second audio preference database and an audio database. The second member database is configured to store the basic information of each of the members, the second audio preference database is configured to store the audio preference record of each of the members, and the audio database is configured to store a plurality of audio files for member download. Under a condition that the first and second short-range wireless communication elements are in communication with each other, the network communication device automatically transmits the basic information set by the client to the information management server through the internet network. After the information management server confirms the basic information, the wearable electronic device automatically uploads the body signal record and the audio preference record stored therein to the information management server through the network communication device, and the information management server respectively stores the body signal record and the audio preference record to the body signal database and the first audio preference database corresponding to the client. The information management server automatically uploads the audio preference stored in the first audio preference database to the streaming audio server, and the streaming audio server then stores the audio preference record in the second audio preference database corresponding to the client. After confirming the basic information transmitted from the network communication device, the streaming audio server downloads the audio files stored in the audio database and matched with the audio property of the audio preference record stored in the second audio preference database, to the wearable electronic device through the internet network and the network communication device in a sequential order, for the member to listen. Therefore, it is not necessary to dispose a high-power Ethernet communication element, a long-range wireless communication element, relevant communication connection interfaces, large-volume memory and rechargeable battery in the wearable electronic device. By means of technology of the present disclosure, the wearable electronic device can be designed to be more compact, lighter and have lower power consumption, so as to be conveniently worn on the client and enable the client to use the wearable electronic device in considerable time by just using a small rechargeable battery.

Other objective of the present disclosure is to provide the wearable electronic device including at least one positioning element, and the microprocessor is electrically connected with the at least one positioning element, and respectively receives motion messages measured by the at least one positioning element and then stores the motion messages to the storage element as a motion record, and the information management server includes a motion record database configured to store a motion record of each of the members. Under the condition that the first and second short-range wireless communication elements are in communication with each other, the wearable electronic device automatically uploads the motion record to the information management server through the network communication device and the internet network in the sequential order, and stores the motion record to the motion record database corresponding to the client, so that the client can perform search, downloading, and subsequent editing on the motion record anytime through the network communication device.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic structural view of an electronic commerce system of the present disclosure.

FIG. 2 is a block diagram of a wearable electronic device of the present disclosure.

FIG. 3 is a block diagram of a network communication device of the present disclosure.

FIG. 4 is a schematic view of appearance of a charging device with network communication capacity, in accordance with the present disclosure.

FIG. 5 is a flow chart of an operation process of the electronic commerce system of the present disclosure, wherein FIG. 5 is composed of FIG. 5A and FIG. 5B joined together by the connector A.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

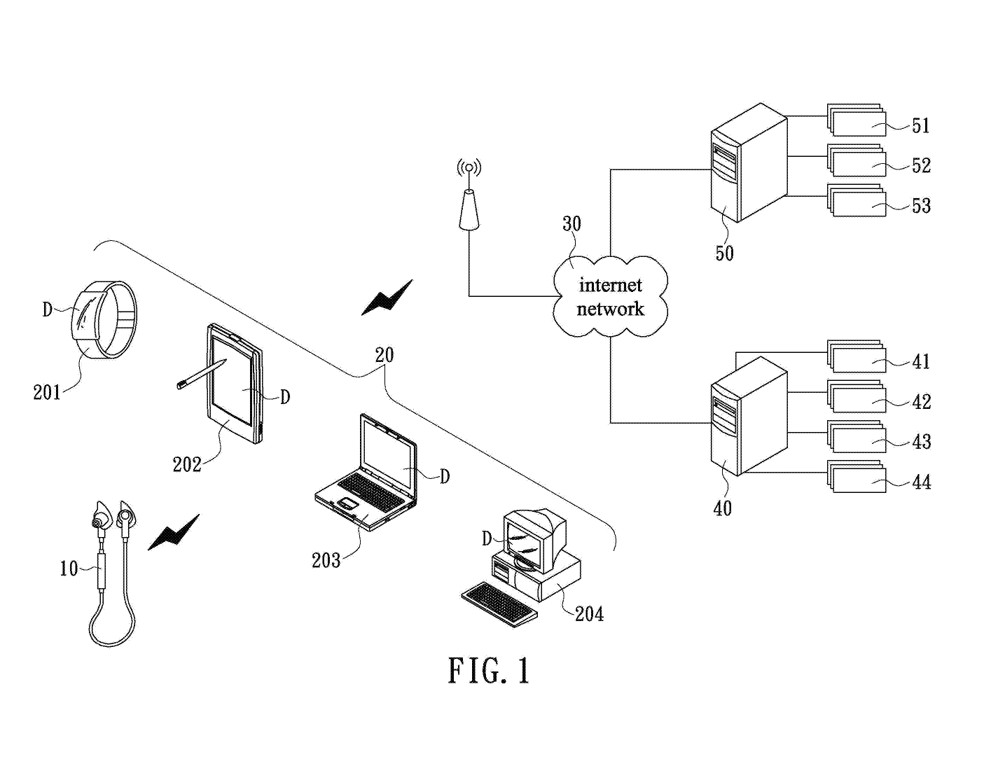

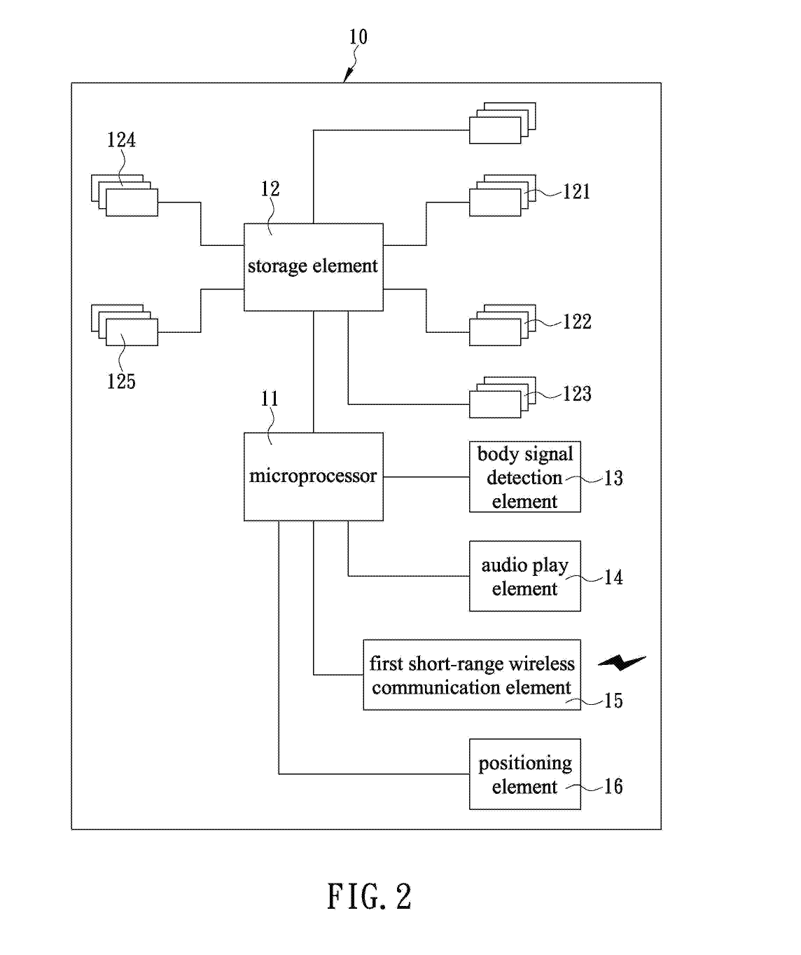

The present disclosure provides an electronic commerce system capable of automatically recording and updating data of a wearable electronic device to a cloud end. Please refer to FIG. 1 which shows a preferred embodiment of the present disclosure. An electronic commerce system includes at least one wearable electronic device 10, at least one network communication device 20, an information management server 40 and at least one streaming audio server 50. Preferably, the wearable electronic device 10 can be a headphone or an electronic band which can be worn on a client. Please refer to FIG. 2. The wearable electronic device 10 at least includes a microprocessor 11, a storage element 12 (such as memory), at least one body signal detection element 13 (such as a detection element capable of measuring the client's temperature, heartbeat, blood pressure or consumed calories), an audio play element 14 and a first short-range wireless communication element 15 (such as a Bluetooth communication element). The microprocessor 11 is electrically connected with the elements 12 through 15 respectively, and configured to execute a plurality of application programs stored in the storage element 12, thereby completing actions described below.

(1) Action of controlling the audio play element 14 to play a plurality of audio files 122 (such as music file, news file, audiobook file and so on) stored in the storage element 12.

(2) Action of storing the client's body signal (such as data of temperature, heartbeat or blood pressure) which is measured by the body signal detection element 13, in the storage element 12 to be a body signal record 123.

(3) Action of storing audio properties (such as singer name, band name, music style, news type, author name, audiobook style and so on) of the audio file being played by the audio play element 14 in the storage element 12 to be an audio preference record 124.

(4) Action of interchanging and updating the information of the application programs 121, the audio file 122, the body signal record 123 and audio preference record 124 with an external device in short-range communication through the first short-range wireless communication element 15.

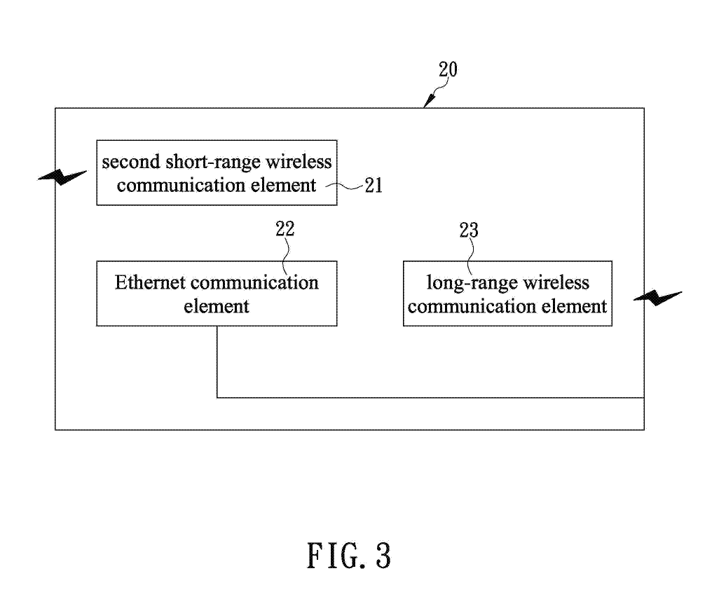

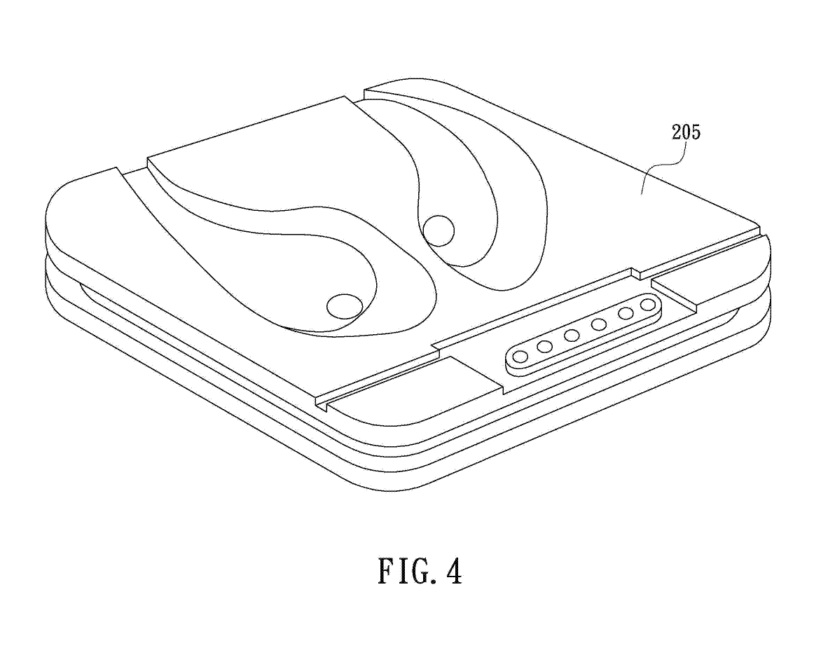

Please refer to FIGS. 1, 3 and 4. In the embodiment, the network communication device 20 can be a smart watch 201, a smart phone 202, a tablet computer or a notebook computer 203, a desktop computer 204 or a charging device 205 having a network communication function, which includes a second short-range wireless communication element 21, an Ethernet communication element 22 and a long-range wireless communication element 23 (such as a Wi-Fi wireless communication element). The network communication device 20 can be linked with the wearable electronic device 10 through the second short-range wireless communication element 21 and the first short-range wireless communication element 15 (as shown in FIG. 2) in a sequential order, and can be linked with the internet network 30 through the long-range wireless communication element 23 or directly through the Ethernet communication element 22, for information interchanging or updating. Please refer back to FIG. 1. In the embodiment, the information management server 40 is located in a cloud end of the internet network 30 and linked with the internet network 30, and includes a first member database 41, a body signal database 42 and a first audio preference database 43. The first member database 41 stores each member's basic information (such as the member's name, mailing address, device identifier and password). The body signal database 42 and the first audio preference database 43 are configured to respectively store each member's body signal record and audio preference record. The streaming audio server 50 is also located in the cloud end of the internet network 30 and linked with the internet network 30. The streaming audio server 50 includes a second member database 51, a second audio preference database 52 and an audio database 53. The second member database 51 is configured to store each member's basic information (such as the member's name, mailing address, device identifier and password), and the second audio preference database 52 is configured to store each member's audio preference record, and the audio database 53 is configured to store a plurality of audio files for member download.

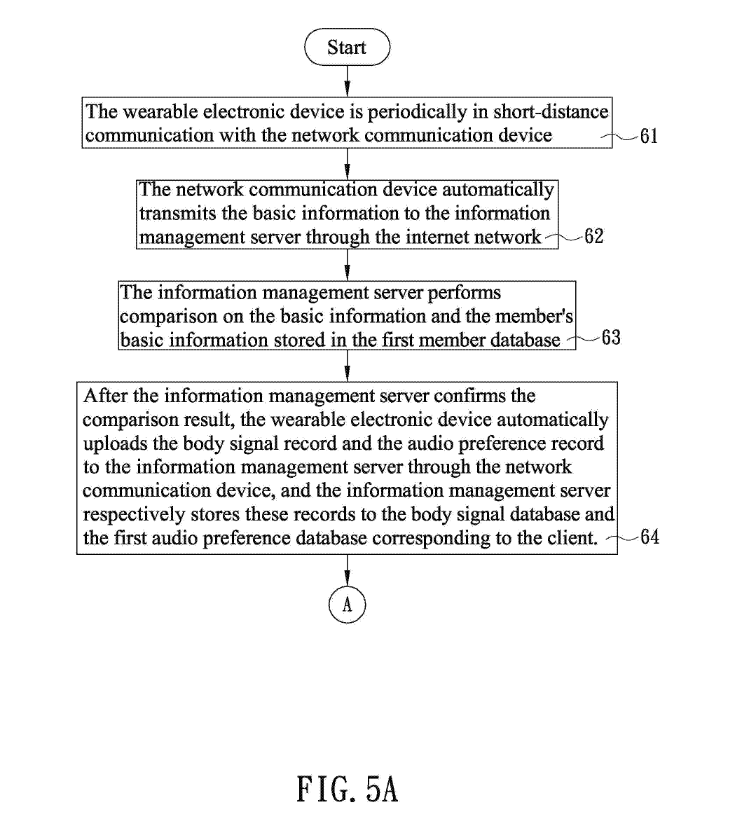

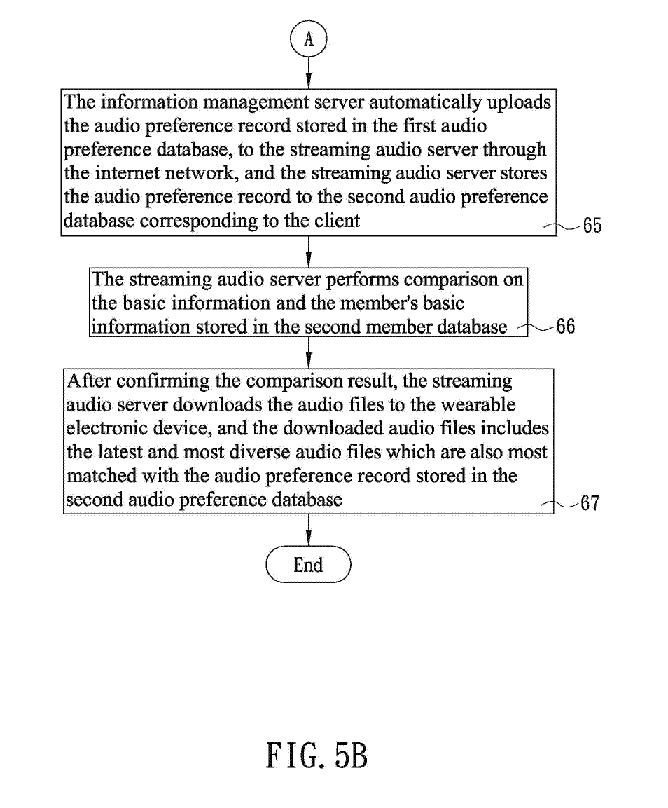

Please refer back to FIGS. 1-3, 5A, and 5B. In the embodiment, the electronic commerce system of the present disclosure controls the devices and elements to execute following steps in a sequential order:

(61) The wearable electronic device 10 is periodically in short-distance communication with the network communication device 20 which is carried with or usually in contact with the client.

(62) Under a condition that the first short-range wireless communication element 15 is in short-distance communication with the second short-range wireless communication element 21, the network communication device 20 automatically transmits the basic information (such as name, mailing address, device identifier and password) set by the client, to the information management server 40 through the internet network 30.

(63) After receiving the basic information set by the client, the information management server 40 performs analysis comparison on the basic information set by the client and the member's basic information stored in the first member database 41.

(64) After the information management server 40 confirms the comparison result, the wearable electronic device 10 automatically uploads the body signal record 123 and the audio preference record 124 stored inside, to the information management server 40 through the network communication device 20, and the information management server 40 respectively stores these records to the body signal database 42 and the first audio preference database 43 corresponding to the client.

(65) The information management server 40 automatically uploads the audio preference record 124 stored in the first audio preference database 43, to the streaming audio server 50 through the internet network 30, and the streaming audio server 50 stores the audio preference record 124 to the second audio preference database 52 corresponding to the client.

(66) After receiving the basic information transmitted from the network communication device 20, the streaming audio server 50 performs analysis comparison on the basic information set by the client and the member's basic information stored in the second member database 51.

(67) After confirming the comparison result, the streaming audio server 50 downloads the audio files to the wearable electronic device 10 for client to listen, through the internet network 30 and the network communication device 20. The downloaded audio files includes the latest and most diverse audio files which are also most matched with the audio properties of the audio preference record 124 stored in the second audio preference database 52.

Therefore, it is not necessary to install high-power communication element (such as the Ethernet communication element 22 or the long-range wireless communication element 23) and relevant communication connection interface, large-volume of memory and rechargeable battery in the wearable electronic device 10, so the wearable electronic device 10 can be more easily designed as a wearable device with a lighter, more compact structure and having less power consumption, whereby the user can wear the wearable electronic device 10 conveniently and the wearable electronic device 10 just needs smaller rechargeable battery to supply power for the client's operation in considerable time. In addition, in cooperation with the network communication device 20, the wearable electronic device 10 can anytime stores the client's body signal record 123 and audio preference record 124 to the large volume of storage space provided by the information management server 40, so that the client can anytime perform search, downloading, and subsequent editing through the network communication device 20. In addition, in cooperation with other network communication device (such as the charging device 205 having network communication function), the wearable electronic device 10 can directly download the audio file which is latest, most diverse and matching with the client's preference, from the streaming audio server 50 anywhere.

Please refer back to FIGS. 1-3. In other preferred embodiment of the present disclosure, the wearable electronic device 10 further includes at least one positioning element 16. Preferably, the positioning element 16 can be a GPS element, a barometer, a magnetometer, a gyroscope, or an accelerometer. The microprocessor 11 is electrically connected with the at least one positioning element 16 to receive a motion message (such as the client's motion speed, altitude, trajectory) measured by the positioning element 16, and store the motion message to the storage element 12 as a motion record 125. The information management server 40 further includes a motion record database 44 which is configured to store each member's motion records. In a condition that the first short-range wireless communication element 15 and the second short-range wireless communication element 21 are in communication with each other, the wearable electronic device 10 can automatically upload the motion record 125 to the information management server 40 through the network communication device 20 and the internet network 30 in a sequential order, and the information management server 40 stores the motion record 125 in the motion record database 44 corresponding to the client, so as to provide the client to anytime perform search, downloading and subsequent editing through the network communication device 20 in future.

Please refer back to FIGS. 1 and 2. In aforesaid embodiment of the present disclosure, each of the network communication devices 20 (such as the smart watch 201, the smart phone 202, the tablet computer or notebook computer 203, or the desktop computer 204) has a display D, so that the client can edit the audio preference record 124 stored in the wearable electronic device 10 through the network communication device 20 and the display D. The basic information set by the client can be stored in the wearable electronic device 10 or the network communication device 20, to be accessed by the network communication device 20 anytime, and can be respectively transmitted to the information management server 40 and the streaming audio server 50. On the other hand, the network communication device 20 may be other network communication device not having the display, such as the charging device 205 shown in FIG. 4, and the basic information set by the client should be stored in the wearable electronic device 10. When the wearable electronic device 10 and the network communication device 20 are in short-distance communication with each other, the wearable electronic device 10 can respectively transmit the basic information, which is set by the client, to the information management server 40 and the streaming audio server 50 through the network communication device 20.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electronic commerce system capable of automatically recording and updating information stored in at least one wearable electronic device by a cloud end, comprising:
the wearable electronic device configured to be worn on a client and at least comprising a microprocessor, a storage element, at least one body signal detection element, an audio play element and a first short-range wireless communication element, wherein the microprocessor is electrically connected with the storage element, the body signal detection element, the audio play element and the first short-range wireless communication element respectively and configured to execute a plurality of application programs stored in the storage element for controlling the audio play element to play a plurality of audio files stored in the storage element, the microprocessor is configured to store the client's body signal measured by the body signal detection element to the storage element as a body signal record and store an audio property of the audio file being played by the audio play element to the storage element as an audio preference record, and the microprocessor is configured to interchange and update information of the application programs, the audio files, the body signal record and the audio preference record with an external device through the first short-range communication element;
at least one network communication device comprising a second short-range wireless communication element, an Ethernet communication element and a long-range wireless communication element, configured to link with the wearable electronic device through the first and second short-range wireless communication elements, and configured to link with internet network through the long-range wireless communication element or directly through the Ethernet communication element, so as to perform information interchanging and updating;
an information management server located in a cloud end of the internet network and linked with the internet network, and comprising a first member database, a body signal database and a first audio preference database, wherein the first member database is configured to store basic information of each of members, and the first audio preference database and the body signal database are configured to respectively store the audio preference record and the body signal record of each of the members; and
at least one streaming audio server located in the cloud end of the internet network and linked with the internet network, and comprising a second member database, a second audio preference database and an audio database, and wherein the second member database is configured to store the basic information of each of the members, the second audio preference database is configured to store the audio preference record of each of the members, and the audio database is configured to store a plurality of audio files for the members to download;
thereby, under a condition that the first and second short-range wireless communication elements are in communication with each other, the network communication device automatically transmits the basic information set by the client to the information management server through the internet network and, after the information management server confirms the basic information, the wearable electronic device automatically uploads the body signal record and the audio preference record stored therein to the information management server through the network communication device, the information management server respectively stores the body signal record and the audio preference record to the body signal database and the first audio preference database corresponding to the client; in the meantime, the information management server automatically uploads the audio preference stored in the first audio preference database to the streaming audio server, and the streaming audio server stores the audio preference record in the second audio preference database corresponding to the client; after confirming the basic information transmitted from the network communication device, the streaming audio server downloads the audio files, which are stored in the audio database and matched with the audio property of the audio preference record stored in the second audio preference database, to the wearable electronic device through the internet network and the network communication device sequentially.

2. The electronic commerce system according to claim 1, wherein the wearable electronic device comprises at least one positioning element, the microprocessor is electrically connected with the positioning element and receives motion messages measured by the positioning element and stores the motion messages to the storage element as a motion record; wherein the information management server comprises a motion record database which is configured to store a motion record of each of the members and, under the condition that the first and second short-range wireless communication elements are in communication with each other, the wearable electronic device automatically uploads the motion record to the information management server through the network communication device and the internet network sequentially, and the information management server stores the motion record to the motion record database corresponding to the client.

3. The electronic commerce system according to claim 2, wherein the network communication device is a smart watch, a smart phone, a tablet computer, a notebook computer or a desktop computer, and comprises a display disposed thereon, and the network communication device is configured to edit the audio preference record stored in the wearable electronic device.

4. The electronic commerce system according to claim 3, wherein the basic information set by the client is stored in the wearable electronic device or the network communication device.

5. The electronic commerce system according to claim 2, wherein the network communication device is a device having a network communication function but not having a display.

6. The electronic commerce system according to claim 5, wherein the basic information set by the client is stored in the wearable electronic device.

7. The electronic commerce system according to claim 1, wherein the basic information set by the client is stored in the wearable electronic device or the network communication device.

8. The electronic commerce system according to claim 2, wherein the basic information set by the client is stored in the wearable electronic device or the network communication device.

9. The electronic commerce system according to claim 3, wherein the basic information set by the client is stored in the wearable electronic device or the network communication device.

10. The electronic commerce system according to claim 4, wherein the basic information set by the client is stored in the wearable electronic device or the network communication device.

11. The electronic commerce system according to claim 5, wherein the basic information set by the client is stored in the wearable electronic device or the network communication device.

12. The electronic commerce system according to claim 6, wherein the basic information set by the client is stored in the wearable electronic device or the network communication device.

13. The electronic commerce system according to claim 7, wherein the first short-range wireless communication element or the second short-range wireless communication element is a Bluetooth communication element, and the long-range wireless communication element is a Wi-Fi wireless communication element.

14. The electronic commerce system according to claim 8, wherein the first short-range wireless communication element or the second short-range wireless communication element is a Bluetooth communication element, and the long-range wireless communication element is a Wi-Fi wireless communication element.

15. The electronic commerce system according to claim 9, wherein the first short-range wireless communication element or the second short-range wireless communication element is a Bluetooth communication element, and the long-range wireless communication element is a Wi-Fi wireless communication element.

16. The electronic commerce system according to claim 10, wherein the first short-range wireless communication element or the second short-range wireless communication element is a Bluetooth communication element, and the long-range wireless communication element is a Wi-Fi wireless communication element.

17. The electronic commerce system according to claim 11, wherein the first short-range wireless communication element or the second short-range wireless communication element is a Bluetooth communication element, and the long-range wireless communication element is a Wi-Fi wireless communication element.

18. The electronic commerce system according to claim 12, wherein the first short-range wireless communication element or the second short-range wireless communication element is a Bluetooth communication element, and the long-range wireless communication element is a Wi-Fi wireless communication element.

19. The electronic commerce system according to claim 13, wherein the positioning element is a GPS element, a barometer, a magnetometer, a gyroscope or an accelerometer.

20. The electronic commerce system according to claim 14, wherein the positioning element is a GPS element, a barometer, a magnetometer, a gyroscope or an accelerometer.

21. The electronic commerce system according to claim 15, wherein the positioning element is a GPS element, a barometer, a magnetometer, a gyroscope or an accelerometer.

22. The electronic commerce system according to claim 16, wherein the positioning element is a GPS element, a barometer, a magnetometer, a gyroscope or an accelerometer.

23. The electronic commerce system according to claim 17, wherein the positioning element is a GPS element, a barometer, a magnetometer, a gyroscope or an accelerometer.

24. The electronic commerce system according to claim 18, wherein the positioning element is a GPS element, a barometer, a magnetometer, a gyroscope or an accelerometer.
